(19) United States
(12) Patent Application Publication
(10) Pub. No.: US 2010/0103868 A1
(43) Pub. Date: Apr. 29, 2010

(54) METHOD FOR MODELING WIRELESS NETWORK COVERAGE UNDER LINE-OF-SIGHT CONDITIONS

(75) Inventors: Kevin Meng, San Ramon, CA (US); Raghvendra Savoor, Walnut Creek, CA (US)

Correspondence Address: AT&T Legal Department - DWT, Attn: Patent Docketing, One AT&T Way, Room 2A-207, Bedminster, NJ, 07921, US

(73) Assignee: AT&T Mobility II LLC, Atlanta, GA (US)

(21) Appl. No.: 12/259,131

(22) Filed: Oct. 27, 2008

(51) Int. Cl. H04W 16/00

(52) U.S. Cl. 370/328

(57) ABSTRACT

A line-of-sight (LOS) wireless communications network uses an initial coverage map to indicate expected performance of at least a portion of the network. Man-made structures, terrain and vegetative barriers may degrade system performance. The initial coverage map is updated using techniques, such as the automatic searching of construction database information, satellite imaging, actual system performance measurements, and failed installation attempts to generate a revised coverage map. The measurement techniques may be used alone or in combination to generate the revised coverage map. Other information regarding additions to the LOS wireless network or the introduction of other wireless networks within the area may be used to generate the revised coverage map.

### BACKGROUND OF THE INVENTION

1. Field of the Invention

The present invention is directed generally to a wireless communication network and, more particularly, to techniques for modeling wireless network coverage under line-of-sight conditions.

2. Description of the Related Art

Wireless communication networks are an important form of communication and provide great flexibility for an end-user. The presence of wireless networks is increasing throughout the country.

Multiple service providers offer consumers a variety of options, such as user-selected bandwidth availability, service level selection, and the like. As new wireless network infrastructure is added, it is desirable to determine the coverage that will be provided by the new infrastructure. For example, when wireless communication service is initially provided in a town or city, the service provider will install one or more base stations to provide coverage throughout a selected geographic region. It is desirable for the service provider to determine the extent of coverage and to determine whether there are “holes” in the existing coverage. That is, it is desirable to determine where there are areas of poor or no coverage.

Many communication networks provide expanded capability using a high frequency communication link between the base station and a consumer premise equipment (CPE). With high frequency communication networks, coverage is generally dependent on line-of-sight (LOS) conditions between the base station and a CPE. However, those skilled in the art will appreciate that high frequency communication may be adversely affected by a number of factors. For example, buildings and other man-made structures block LOS transmissions. Similarly, natural terrain, such as mountains, valleys, and the like also serve to block LOS signals. Even plants, shrubs, trees, and the like may also block LOS transmissions.

When infrastructure, such as a new base station, is introduced, the service provider may typically perform initial measurements to determine coverage conditions for the new portion of the wireless communication network. However, conditions often change due to a number of factors. Accordingly, it can be appreciated that there is a significant need for a technique to model wireless network coverage under such changing conditions. The present invention provides this, and other advantages, as will be apparent from the following detailed description and accompanying figures.

### BRIEF DESCRIPTION OF THE SEVERAL VIEWS OF THE DRAWING(S)

FIG. 1 illustrates a simplified wireless communication network.

FIG. 2 is a diagram illustrating infrastructure of the wireless network of FIG. 1 and the effect of structures and terrain in blocking the LOS signals.

FIG. 3 is a flow chart illustrating the operation of the system of FIGS. 1 and 2.

FIG. 4 is a functional block diagram illustrating the hardware components used to generate the initial coverage map and the updated coverage map.

### DETAILED DESCRIPTION OF THE INVENTION

As discussed in the background of the invention, high frequency wireless networks, such as a WiMax network, generally provide coverage under line-of-sight (LOS) conditions. One skilled in the art will appreciate that communications between the network and a consumer may still be acceptable even with compromised LOS conditions.

When a network is initially installed or when additional network infrastructure is added, it is desirable to model the coverage so that the service provider can plan effectively to maximize coverage and for growth of the network.

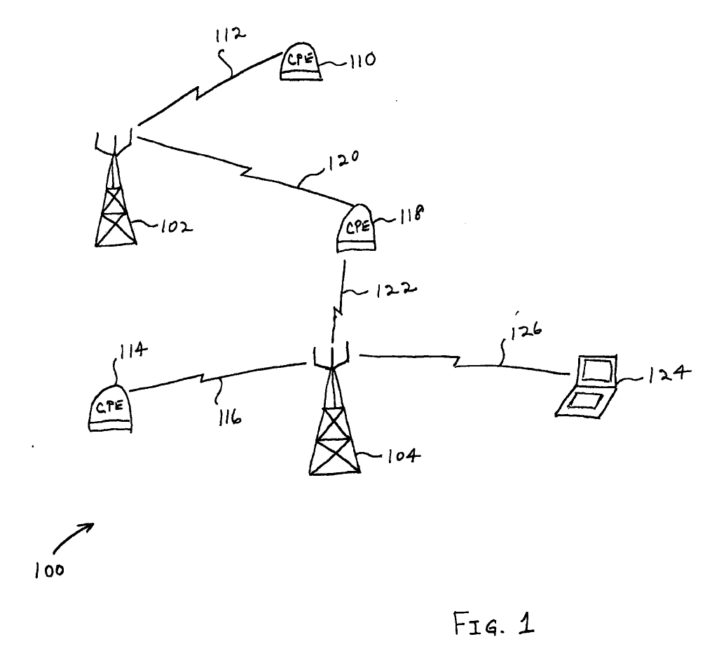

FIG. 1 illustrates a simplified network 100 having a base station 102 and a base station 104. As illustrated in FIG. 1, a consumer premise equipment (CPE) 110 communicates with the base station 102 via a communication link 112. A CPE 114 is coupled to the base station 104 via a communication link 116. A CPE 118 is coupled to the base station 102 via a communication link 120 and can also communicate with the base station 104 via a communication link 122. Known techniques may be used to determine which base station (i.e., the base station 102 or the base station 104) is most suitable for communicating with the CPE 118. That decision may be based on higher signal quality, traffic load balancing amongst the base stations, or combinations of factors. FIG. 1 also illustrates a portable computer 124 coupled to the base station 104 via a communication link 126.

Thus, the network 100 of FIG. 1 may include fixed wireless devices, such as the CPE 110, and portable wireless devices, such as the portable computer 124. Those skilled in the art will appreciate that the network architecture of FIG. 1 is a highly simplified diagram. In a typical implementation, the network 100 would have many base stations with many consumer devices (e.g., the CPE 110 and/or the portable computer 124) coupled to each base station. In addition, the simplified diagram of FIG. 1 does not include control mechanisms, such as base station controllers, centralized network controllers, and the like. Those elements are known in the art and need not be described in greater detail herein.

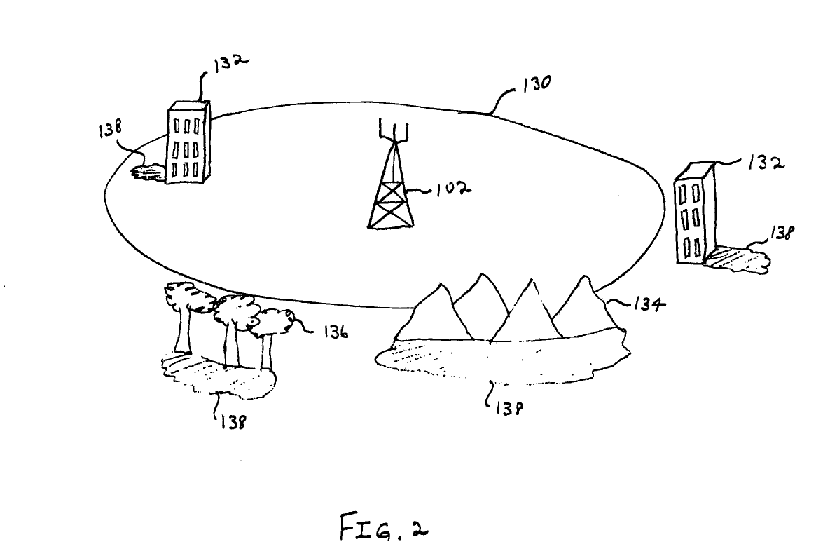

FIG. 2 illustrates the position of the base station 102 and demonstrates the effect of obstructions on LOS communications. In a typical implementation, it is desirable for the base station 102 to be obstruction free for most or all of a first fresnel zone 130. It is not always possible to position the base station 102 in such a location. FIG. 2 illustrates man-made structures 132, such as buildings, that may block the LOS communication link between the base station 102 and consumer equipment (e.g., the CPE 110). In addition, terrain 134, such as mountains, valleys, and the like may also inhibit an LOS communication link. Those skilled in the art will appreciate that terrain 134 may have a widespread impact on LOS communication with the base station 102.

In addition, natural structures 136, such as trees, shrubbery, and the like may also have an impact on LOS communication with the base station 102. While the effect of natural structures 136 may be less widespread than the terrain, it may nonetheless cause a serious degradation of the signal quality. Those skilled in the art will appreciate that the effect of natural structures 136, such as trees, may change on a seasonal basis. For example, leaves in the summertime may create a greater barrier to LOS communication with the base station 102, than a bare tree with no leaves in wintertime. Thus, there are seasonal variations in the effect of natural structures 136 on the LOS communication throughout the network 100.

Each of the examples of barriers to the LOS communication create a potential blackout zone 138. The blackout zone 138 may be a complete blackout where no possible communication may occur with the base station 102 or may provide a degraded signal quality such that network performance is unacceptable.

As previously discussed, conventional network planning may include an initial coverage map that indicates the expected performance of the wireless network under LOS conditions. However, changing conditions, such as the construction or destruction of man-made structures 132, changes in terrain 134, and changes in natural structures 136 alter the coverage within the wireless network. The present disclosure is directed to techniques for modifying an initial coverage map to update the coverage map and provide more current information.

An initial coverage map is often generated by taking RV measurements throughout the region surrounding a newly-installed portion of infrastructure. For example, assume that the base station 102 in FIG. 2 has recently been installed and added to the network 100. To determine the coverage area of the base station 102, a van or other vehicle may be equipped with radio equipment and an external antennae and drive throughout the region surrounding the base station 102. This drive-by test of the surrounding neighborhood provides signal strength measurements at various locations throughout an area of coverage for the base station 102. With a drive-by survey, the network 100 may generate initial signal strength at different locations identified by latitude, longitude, and height. Typically, the initial coverage map is constructed down to the neighborhood block or street level, based on drive-by measurements. If a sufficient number of test measurements are performed, the initial coverage map will provide information regarding signal strength at various locations, including signal strength, if any, in the blackout zones 138.

Alternatively, or in addition to drive-by testing, cell planners may use analytical techniques to determine a theoretical coverage for the base station 102 in the example of FIG. 2. Analytical test results are base on theoretical propagation characteristics. Analytical models, such as Stanford University Interim (SUI) model, are applied to estimate the signal propagation. For example, knowing that a base station antennae is at a certain height and transmits a predetermined signal strength, it is possible to use known atmospheric propagation characteristics for the selected frequencies to determine the likely theoretical signal strength at various locations throughout the area of coverage. Analytical techniques may provide a lower cost approach to determining an initial coverage map but may be less accurate since it cannot accurately predict the effects of barriers, such as the man-made structures 132, terrain 134, and natural structures 136.

Using conventional techniques, an initial coverage map may be generated. Subsequent to the generation of the initial coverage map, the system 100 utilizes the techniques described herein to generate an updated coverage map. When considering man-made structures, one skilled in the art will recognize that any man-made structures along the transmission path may have a significant impact on the LOS conditions. Changes in structures within the region covered by the wireless network (e.g., the area surrounding the base station 102 in FIG. 2) can be determined using satellite imaging and/or access to public records. Although satellite images are not updated on a frequent basis, satellite imaging can be used to identify the introduction of new man-made structures 132 and/or the elimination of existing man-made structures. For example, new satellite images may be compared to an archived image of the same geographical area. Using known techniques, it is possible to align the images and generate a difference image that shows changes between the new satellite image and the archived satellite image. As a result of the differences, the system 100 can determine that new structures have been introduced or existing structures eliminated.

Alternatively, or in combination with satellite imaging, it is possible to use construction data from local, city, or county databases to determine which houses in a particular region may have complete LOS conditions, partial LOS conditions, or non line-of-sight (NLOS) conditions. An NLOS condition may correspond to the blackout zone 138 in FIG. 2. In addition, public database records may be used to determine specifications regarding man-made structures. For example, public database records may indicate the size and expected height of a new building under construction. The system 100 may incorporate this data in determining a new blackout zone 138 that will result from the construction of a new building. Similarly, the system 100 may generate a modified coverage map based on other man-made structures, such as bridges, highways, and the like. The data collected on man-made structures 132 may be incorporated into the modified coverage map.

Satellite imaging may also be used to estimate the adverse effects of terrain 134 and/or natural structures 136 in a coverage zone. Again, satellite imaging, such as Google Earth views provide detailed images of surface features, such as trees and shrubs. Using such satellite images, it is possible to estimate the effect of trees or other shrubs for LOS coverage in a neighborhood. The network 100 uses the satellite imaging to identify trees on a path between the base station 102 and the region surrounding the base station. It is also possible to estimate the tree height and tree cover using historical data and taking into account the seasonal effect on tree covered density. That is, trees having full leaves in the summer have a different effect on LOS transmissions than a bare tree having no leaves in the wintertime. The system 100 can utilize terrain and vegetative cover information to provide a modified coverage map. As described above, the modified coverage map may also be adjusted for seasonal variations.

In addition, performance measurement data for existing customers can be used to modify the coverage map. When a particular CPE (e.g., the CPE 110 in FIG. 1) is installed, performance measurements are used to monitor coverage in that particular location. For example, the system 100 can monitor RF performance by measuring the downlink and uplink maximum data rates and through-puts as well as the downlink and uplink signal-to-noise ratio (SNR) as well as modulation level for successful transmission. In addition, the system 100 may monitor radio link failures. Such performance data for a single CPE provides only minimal benefit to the system 100 in generating a modified coverage map. However, in a typical network, there may be hundreds of CPEs geographically distributed in a region that are connected to a single base station. Thus, the cumulative effect of data generated by hundreds of CPEs has a very beneficial effect when considering modifications to the coverage map.

In addition to performance data for installed CPEs, it is possible to utilize data from a failed CPE installation to further generate an updated coverage map. For example, if a CPE is to be installed at a specific location and, during installation it is determined that signal quality is insufficient, the data from that failed installation may be used to further generate the updated coverage map. There may be a number of reasons for failed installation, such as LOS blockage due to man-made structures 132, terrain 134, and/or natural structures 136.

Thus, the system 100 collects data from a variety of independent sources and integrates the data in a meaningful way to create the modified coverage map. The modified coverage map may be generated periodically, upon request from the service provider, or on a more or less continuous basis as additional CPEs are added and additional performance data made available to the system 100.

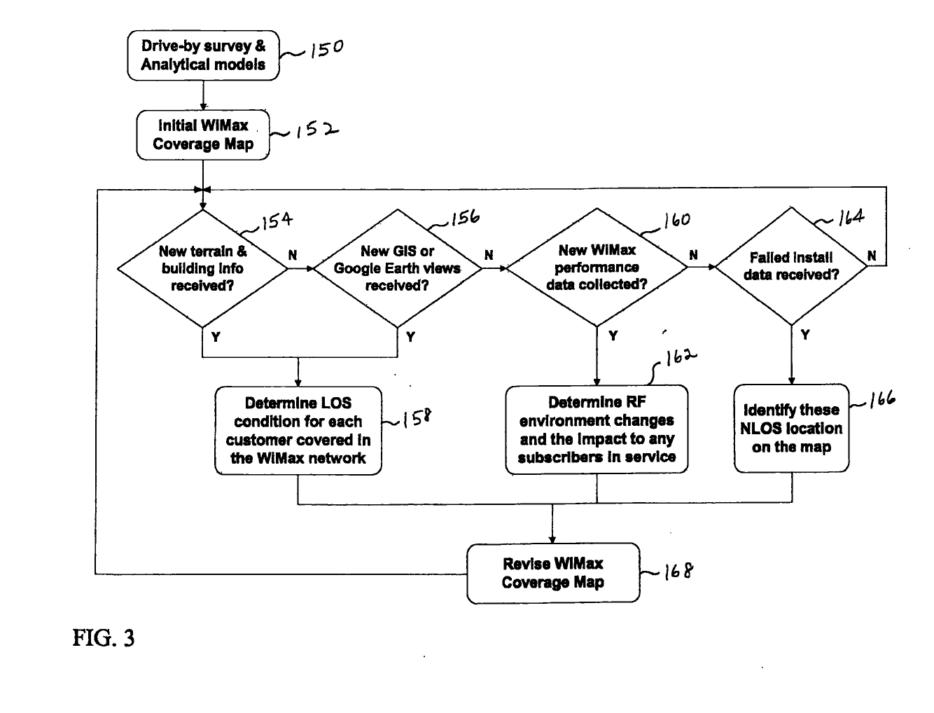

FIG. 3 is a flowchart illustrating an example embodiment of the system 100. Following the installation of new infrastructure, such as the base station 102 in FIG. 2, the network 100 performs a drive-by survey and uses analytical models to collect data in step 150. In step 152, the network 100 generates an initial coverage map. In decision 154, the network 100 determines whether new terrain and/or building information has been received. If no new terrain or building information has been received, the result of decision 154 is NO and in decision 156, the network determines whether new geographic information system (GIS) data or other satellite imaging views, such as Google Earth views, have been received.

If new terrain and/or building information has been received, the result of decision 154 is YES. Similarly, if new satellite imaging information has been received, the result of decision 156 is YES. In the event of a YES decision in either the decision 154 or the decision 156, the network 100 goes to step 158 to determine the LOS condition for a coverage area. In one embodiment, the network 100 may determine an overall coverage map for the entire region covered by the base station 102. Alternatively, the network 100 may determine the LOS condition of a particular subscriber within the network 100.

If no new satellite imaging data has been received, the result of decision 156 is NO. In that event, the network 100 moves to decision 160 to determine whether new performance data has been collected. If new performance data has been collected, the result of decision 160 is YES and, in step 162, the network 100 determines any RF environment changes and the impact to any subscribers of the particular service provider as a result of the newly available performance data. As discussed above with respect to step 158, step 162 may be interpreted as determining changes in the RF environment for an entire zone of coverage for the base station 102 or may limit the analysis to environmental changes that have an impact on the individual subscribers of the particular service provider.

If no new network performance data is available, the result of decision 160 is NO and, in decision 164, the network 100 determines whether any additional data has been received as a result of failed installations. If no failed installation data has been received, the result of decision 164 is NO and the network returns to decision 154 to continue monitoring for additional data that may used to generate the updated coverage map.

If failed installation data has been received, the result of decision 164 is YES and, in step 166, the network 100 determines the identity of the NLOS location on the coverage map.

The data determined as a result of step 158, step 162, and step 166 may all be used by the network 100 in step 168 to generate a revised coverage map. Following the generation of the revised coverage map in step 168, the network 100 returns to step 154 to continue the monitoring process. In this manner, it is possible to generate revised coverage maps that are more up-to-date than the initial coverage map. The service provider may use the modified coverage map for network planning purposes as well as for marketing purposes to tout its ability to provide service coverage in certain areas.

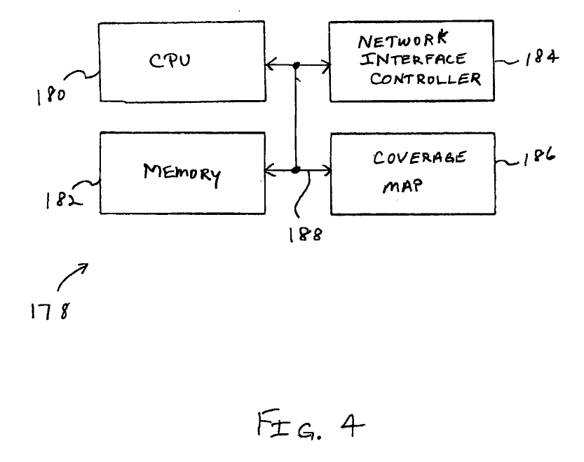

FIG. 4 is a functional block diagram illustrating the hardware components used to generate the initial coverage map and the updated coverage map. Those skilled in the art will recognize that the components are largely conventional computer components such as may be found in a personal computer (PC) 178 or similar computing device. The PC 178 includes a central processing unit (CPU) 180 and a memory 182. In general, the memory 182 stores instructions and data that control the operation of the CPU 180. The CPU 180 may be implemented using a variety of known technologies such as a conventional micro-processor, micro-controller, digital signal processor, or the like.

Similarly, the memory 182 may be implemented using a variety of known technologies. The memory 182 may include random access memory, read-only memory, flash memory, programmable memory, or the like. In one embodiment, at least a portion of the memory 182 may be integrated into a device with the CPU 180. The present invention is not limited by the specific form of components used to implement the CPU 180 or the memory 182.

FIG. 4 also illustrates a network interface controller (NIC) 184, which controls communication with external data sources, such as the city/county database described above. The NIC 184 may also be used to connect to the network 100 or to an external network, such as the Internet. The NIC 184 may be used to receive satellite imaging data and performance data from the network 100. Those skilled in the art will appreciate that the NIC 184 may be representative of multiple different types of network interfaces, such as an Ethernet connection, or other conventional network connection. The system is not limited by the specific form of the NIC 184.

FIG. 4 also illustrates a coverage map 186, which is representative of a coverage map for, by way of example, the coverage zone proximate the base station 102 in FIG. 2. The coverage map 186 may represent the initial coverage map generated when the base station 102 is first installed. The coverage map 186 is also representative of the updated coverage map that is generated in response to additional data, as illustrated in the flow chart of FIG. 3. The coverage map 186 may be stored in any convenient format and various known data structures (e.g., a table or database) may be used to implement the coverage map 186.

Although not illustrated in FIG. 4, those skilled in the art will appreciate that other conventional components, such as a keyboard, video display, disk drive, and the like are also included. For the sake of clarity, those elements are not illustrated in FIG. 4.

Some components illustrated in FIG. 4, such as the coverage map 186, may be formed as part of the memory 182. However, such components are illustrated as separate blocks in the functional block diagram of FIG. 4 since it performs a separate operational function.

The various components illustrated in FIG. 4 are coupled together by a bus system 188. The bus system 188 may comprise an address bus, data bus, control bus, power bus, and the like. For the sake of convenience, the various busses are illustrated in FIG. 4 as the bus system 188.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A method for modeling coverage in a line-of-sight (LOS) wireless communication network comprising:
performing initial measurements to determine performance of a portion of the wireless network following installation of the portion of the LOS wireless network;
generating an initial coverage map indicating expected performance of the LOS wireless network;
detecting changes in LOS conditions that occur subsequent to the generation of the initial coverage map initial coverage map; and
modifying the initial coverage map to include data related to detected changes in LOS conditions that affect the expected performance of the wireless network to thereby generate a revised coverage map.

2. The method of claim 1 wherein detecting changes in LOS conditions comprises detecting changes in man-made structures made subsequent to the generation of the initial coverage map.

3. The method of claim 2 wherein detecting changes in man-made structures comprises evaluating public records related to man-made structures.

4. The method of claim 2 wherein detecting changes in man-made structures comprises evaluating satellite image data related to man-made structures.

5. The method of claim 1 wherein detecting changes in LOS conditions comprises detecting changes in terrain made subsequent to the generation of the initial coverage map.

6. The method of claim 5 wherein detecting changes in man-made structures comprises evaluating public records related to man-made structures.

7. The method of claim 5 wherein detecting changes in man-made structures comprises evaluating satellite image data related to man-made structures.

8. The method of claim 1 wherein detecting changes in LOS conditions comprises determining actual performance data in the portion of the LOS wireless network and modifying the initial coverage map to include actual performance data.

9. The method of claim 1 wherein detecting changes in LOS conditions comprises measuring performance data in a radio frequency (RF) environment in the portion of the LOS wireless network resulting from changes in RF transmissions in the portion of the LOS wireless network and modifying the initial coverage map to include performance data indicative of changes in the RF environment.

10. The method of claim 1 wherein detecting changes in LOS conditions comprises determining performance data resulting from a failed installation of consumer premise equipment (CPE) in the portion of the LOS wireless network and modifying the initial coverage map to include actual performance data for the CPE filed installation.

11. The method of claim 1 wherein performing initial measurements comprises a measurement performed at a plurality of locations surrounding the portion of the wireless network.

12. The method of claim 1 wherein performing initial measurements comprises calculating a theoretical performance, based on analytic models, at a plurality of locations surrounding the portion of the wireless network.

13. A method for modeling coverage in a line-of-sight (LOS) wireless communication network comprising:
performing initial measurements to determine performance of a portion of the wireless network following installation of the portion of the LOS wireless network;
generating an initial coverage map indicating expected performance of the LOS wireless network;
using a satellite image to detect changes in LOS conditions that occur subsequent to the generation of the initial coverage map initial coverage map; and
modifying the initial coverage map to include data related to detected changes in LOS conditions that affect the expected performance of the wireless network to thereby generate a revised coverage map.

14. The method of claim 13 wherein using a satellite image to detect changes in LOS conditions comprises detecting changes in man-made structures.

15. The method of claim 14, further comprising evaluating public records related to man-made structures.

16. The method of claim 13 wherein using a satellite image to detect changes in LOS conditions comprises detecting changes in vegetative barriers.

17. The method of claim 16, further comprising estimating a size of the vegetative barriers.

18. The method of claim 16, further comprising estimating an effect of the vegetative barriers based on a time of year.

19. A system for modeling coverage in a line-of-sight (LOS) wireless communication network comprising:
a first data structure configured to receive initial measurement data indicative of a performance of a portion of the wireless network upon installation of the portion of the LOS wireless network;
a network interface configured to receive a satellite image of the earth, including the portion of the LOS wireless network; and
a processor configured to access the first data structure and generate an initial coverage map indicating expected performance of the LOS wireless network using the initial measurement data;
the processor further configured to use a satellite image generated subsequent to the generation of the initial coverage map to detect changes in LOS conditions that occur subsequent to the generation of the initial coverage map initial coverage map; and
the processor further configured to modify the initial coverage map to include data related to detected changes in LOS conditions that affect the expected performance of the wireless network to thereby generate a revised coverage map.

20. The system of claim 19 wherein the network interface is configured to access public records related to man-made structures and the processor is further configured to modify the initial coverage map based on the public record data.
